(19) United States
(12) Patent Application Publication
(10) Pub. No.: US 2012/0005724 A1
(43) Pub. Date: Jan. 5, 2012

(54) METHOD AND SYSTEM FOR PROTECTING PRIVATE ENTERPRISE RESOURCES IN A CLOUD COMPUTING ENVIRONMENT

(75) Inventor: Jaushin Lee, Saratoga, CA (US)

(73) Assignee: Imera Systems, Inc., San Jose, CA (US)

(21) Appl. No.: 13/234,933

(22) Filed: Sep. 16, 2011

Related U.S. Application Data
(63) Continuation-in-part of application No. 12/368,301, filed on Feb. 9, 2009.
(60) Provisional application No. 61/403,888, filed on Sep. 23, 2010.

(51) Int. Cl. G06F 17/00

(52) U.S. Cl. 726/1

(57) ABSTRACT

A method for protecting private enterprise computing resources in a cloud computing environment includes determining a virtual topology comprising a secure computing zone, which includes a secure virtual vault, associated with an enterprise application of a private enterprise in a cloud computing environment. A traffic control policy associated with the secure computing zone is determined that comprises a plurality of security rules that define data traffic flow into, out of, and within the associated secure computing zone. A plurality of cloud computing nodes is selected and associated with the secure virtual vault. Any of the cloud computing nodes is a virtual computer or a physical computer device. The traffic control policy is automatically implemented in each of the cloud computing nodes associated with the secure virtual vault, where each cloud computing node is configured to enforce the plurality of security rules at an operating system level of the cloud computing node.

### CLAIM OF PRIORITY

This application is a continuation-in-part of U.S. patent application Ser. No. 12/368,301, filed Feb. 9, 2009, the disclosure of which is incorporated herein by reference in its entirety. This application also claims the benefit of U.S. Provisional Patent Application 61/403,888 entitled Virtual Topology and Grid Based Security Control for Private and Public Clouds, by Jaushin Lee, filed Sep. 23, 2010, the entire contents of which are also incorporated herein by reference.

### BACKGROUND

Many corporate enterprises collect and store important and sensitive business information and critical business applications in one or more central “locations” referred to as “clouds.” A cloud typically comprises a plurality of computers, physical and/or virtual machines, collectively referred to as cloud computing nodes. The nodes can be clustered physically and/or distributed, that is, they can reside in a single location or be distributed in several locations, communicatively coupled to one another by a network, e.g., the Internet or a private network. Alternatively or additionally, cloud computing nodes can be virtual machines provided by one or more physical computer machines, which can be clustered and/or distributed. Each virtual machine in the cloud environment can host a virtualized operating system (OS), and can be communicatively coupled to another virtual machine via a virtual network.

Consolidating enterprise applications and data in a central cloud environment can reduce the complexity of managing enterprise applications and data on distributed end-point computer nodes, i.e. client devices. In addition, it can optimize efficiency in rolling out enterprise applications and services, and can mitigate risks of leaking sensitive corporate data.

Typically, access to a private enterprise cloud is restricted to authorized users and/or client devices. Thus, the private enterprise cloud and its secure internal network, virtual or physical, are typically protected by several layers of security that are implemented via network devices, e.g., gateway node devices, routers and switches, and external and internal firewalls.

In some cases, a corporate enterprise can purchase and maintain its own physical computing devices, e.g., server farms, which provide a private cloud computing environment. In other cases, a corporate enterprise can lease cloud computing nodes from a cloud service provider, which owns and maintains the physical computing devices that provide the cloud environment. This case is referred to as a public cloud computing environment because the physical computing devices are not controlled and/or owned by the leasing corporate enterprise and, in many cases, the physical computing devices are shared by more than one enterprise. The public cloud computing environment offers cloud computing capabilities to enterprises that may not have the resources to purchase and maintain their own physical computing devices, or may not be able to build such a large server farm in a short period of time.

While centralized cloud computing delivers its promise in solving the end-point management and application management issues and helping prevent corporate data leakage, it also introduces a new set of security challenges as well. For example, when restricted resources, e.g., sensitive business applications and data, are placed together along with unrestricted resources on a cloud environment, users who are authorized to access the unrestricted resources, but unauthorized to access the restricted resources, can potentially gain access to the restricted resources because the restricted resources reside in the same cloud. Moreover, when resources and data are aggregated in a cloud environment, they can become an attractive target for focused cyber attacks on the cloud. When a cyber attack penetrates a cloud, the attacker can potentially obtain many more resources, applications, and data then had the resources been stored in a conventional distributed computing environment.

To address this issue, restricted resources can be statically and permanently “locked-down” using physical hardware-based computing and networking infrastructure techniques. Nevertheless, when such a strategy is adopted, the physical computer device that hosts the restricted resources cannot be easily shared, thus defeating the cost advantages gained from consolidation. Moreover, this approach seriously erodes the enterprise's flexibility to dynamically implement changes to security rules and access policies. For instance, in a fixed network infrastructure for resource segregation, modifying access privileges requires an administrator to modify manually the network settings and configurations of the network node devices, which is very inefficient and is not on demand. In such an environment, it is very difficult, if not impossible, to implement policy based and “elastic” network segregation, which is integrated with user role based access control.

To complicate matters, in a public cloud environment, the physical layer of the cloud infrastructure is typically controlled by the cloud service provider and a renting enterprise is typically not allowed to tamper with internal/external firewall settings and switch/router settings in order to “lock-down” a rented device. While some cloud service providers may offer limited physical programming and control capability, the overall hurdle for the renting enterprise to achieve its security goals can be overwhelming.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a block diagram illustrating an exemplary hardware device in which the subject matter may be implemented;

FIG. 2 is a flow diagram illustrating a method for protecting private enterprise computing resources in a cloud computing environment according to an exemplary embodiment;

FIG. 3 is a block diagram illustrating a system for protecting private enterprise computing resources according to an exemplary embodiment;

FIG. 4 illustrates a network in which a system for protecting private enterprise computing resources can be implemented; and

FIG. 5 is a block diagram illustrating another system for protecting private enterprise computing resources according to an exemplary embodiment.

### DETAILED DESCRIPTION

Methods and systems for protecting private enterprise computing resources in a cloud computing environment are disclosed. According to an embodiment, a resource in a cloud computing environment is protected logically, as opposed to physically by a physical network device. In an embodiment, a server communicatively coupled to a cloud computing environment can be configured to determine a virtual topology comprising a secure computing zone associated with an enterprise application flow of a private enterprise. The secure computing zone can include a secure virtual vault, which is associated with a traffic control policy. The traffic control policy is determined by the server and comprises security rules that define data traffic flow into, out of, and within the associated secure virtual vault. In an embodiment, for example, for a given enterprise application, a security administrator associated with the private enterprise can provide to the server a virtual topology definition and traffic control policy definitions for secure virtual vaults in the virtual topology.

According to an embodiment, once the virtual topology and traffic control policy are determined, a plurality of cloud computing nodes can be selected by the server and automatically associated with the secure virtual vault. A cloud computing node can be a physical computer device or a virtual computer provided by a physical computer device. When the plurality of cloud computing nodes are associated with the secure virtual vault, the server can, in an embodiment, automatically implement the traffic control policy associated with the secure virtual vault in each associated cloud computing node.

In an embodiment, each cloud computing node is configured to enforce the traffic control policy at an operating system level of the cloud computing node. Because the traffic control policy is enforced at the operating system level of each cloud computing node, as opposed to at a physical network level, security rules and access policies can be defined logically and can be dynamically reconfigured without regard to the underlying and existing physical network infrastructure. With this capability, the cloud service provider and its enterprise customers can easily segregate security control duties. That is, in such a model, the cloud service provider can provide and implement a layer of “physical security” to protect the cloud facility up to the operating system level, and the enterprise customers can provide an additional layer of security to protect their enterprise applications deployed in the operating systems.

In an embodiment, the server can transform the data traffic control policy defining how data traffic can flow into, out of, and within the secure virtual vault into an approved resource list, which can be maintained by the operating system of each cloud computing node associated with the secure virtual vault. The approved resource list can include, in an embodiment, network addresses, network ports and/or network protocols associated with other resources, e.g., other cloud computing nodes, applications and/or networks, with which the cloud computing node is allowed to communicate. In an embodiment, approved resources can be defined and modified dynamically by updating the approved resource list, as opposed to reconfiguring the existing hardware network infrastructure.

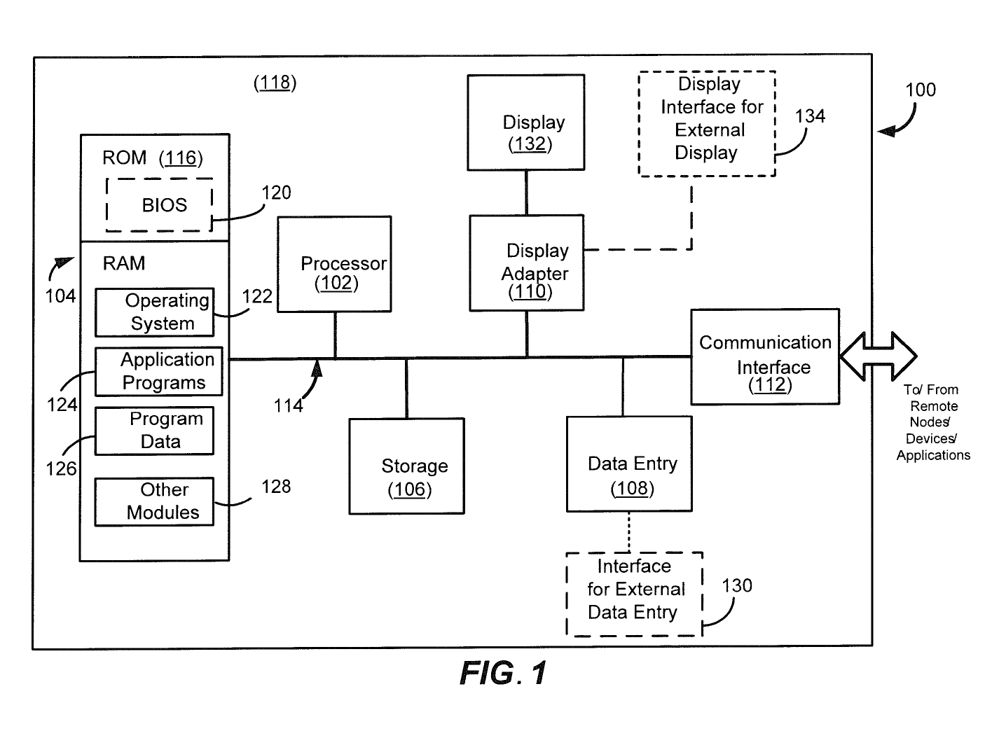

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a physical or virtual hardware device 100, including a processing unit 102, memory 104, storage 106, data entry module 108, display adapter 110, communication interface 112, and a bus 114 that couples elements 104-112 to the processing unit 102. While many elements of the described hardware device 100 can be physically implemented, many if not all elements can also be virtually implemented by, for example, a virtual computing node.

The bus 114 may comprise any type of bus architecture. Examples include a memory bus, a peripheral bus, a local bus, etc. The processing unit 102 is an instruction execution machine, apparatus, or device, physical or virtual, and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the physical or virtual hardware device 100.

It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the device 100.

The device 100 may operate in a networked environment using logical connections to one or more remote nodes (not shown) via communication interface 112. The remote node may be another physical or virtual computer, a server, a router, a peer device or other common network node, and typically includes many or all of the elements described above relative to the device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the device 100, or portions thereof, may be stored in a remote storage device, such as, for example, on a server. It will be appreciated that other hardware and/or software to establish a communications link between the device 100 and other devices may be used.

It should be understood that the arrangement of device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components can be realized, in whole or in part, by at least some of the components illustrated in the arrangement of device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

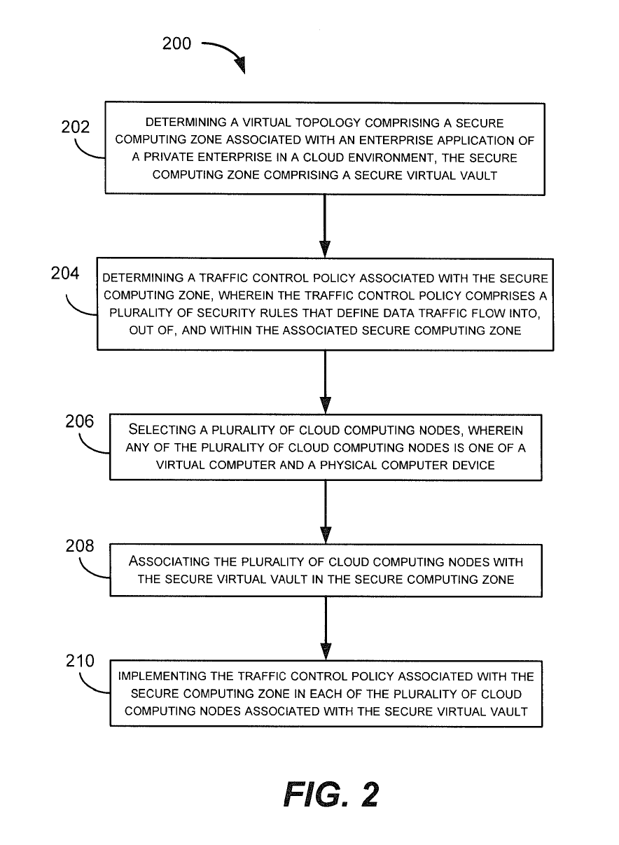

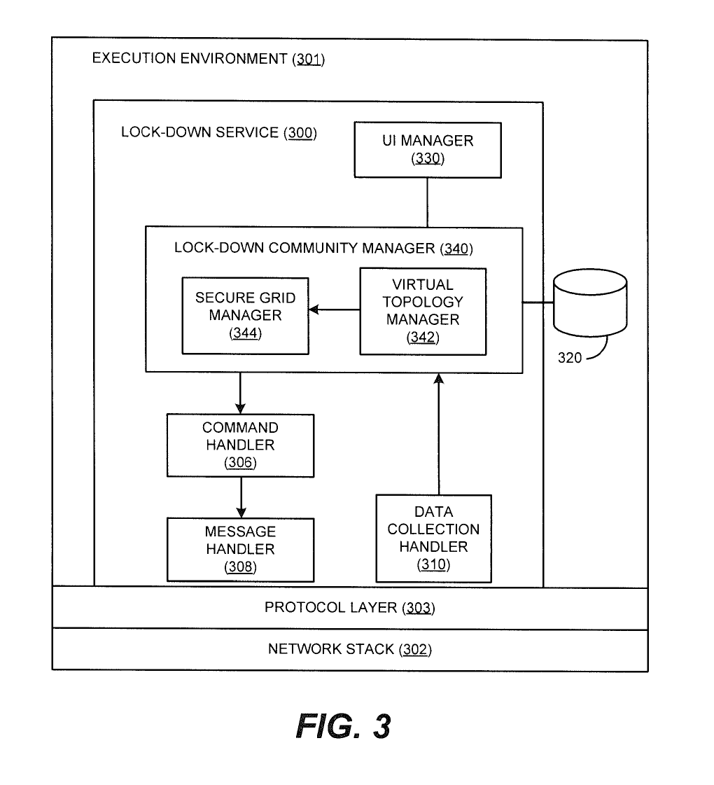

Referring now to FIG. 2, a flow diagram is presented illustrating a method for protecting private enterprise computing resources in a cloud computing environment according to an exemplary embodiment. FIG. 3 is a block diagram illustrating an exemplary system for protecting private enterprise computing resources according to embodiments of the subject matter described herein. The method illustrated in FIG. 2 can be carried out by, for example, at least some of the components in the exemplary arrangement of components illustrated in FIG. 3. The arrangement of components in FIG. 3 may be implemented by some or all of the components of the device 100 of FIG. 1.

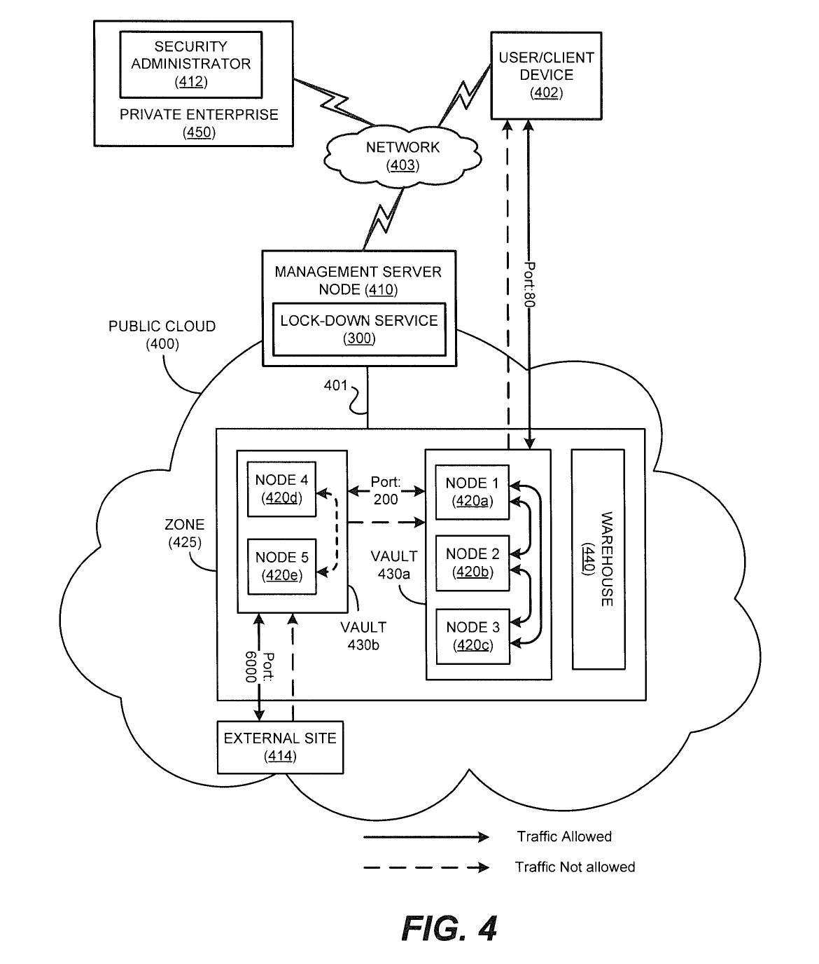

FIG. 3 illustrates components that are configured to operate within an execution environment hosted by a physical or virtual computer device and/or multiple computer devices, as in a distributed execution environment. For example, FIG. 4 illustrates a plurality of cloud computing nodes 420a-420e in a cloud computing environment 400 communicatively coupled to a management server node 410 via a secure control transport channel 401. In an embodiment, the cloud 400 can be a public cloud provided by an independent cloud service provider that leases physical and/or virtual cloud resources to a private enterprise 450 for a fee. The management server node 410 can be a physical or virtual cloud resource in the public cloud environment 400 provided by the independent service provider. Alternatively, the management server node 410 can be in a demilitarized zone (not shown) associated with a secure enterprise network of the private enterprise 450. In an embodiment, the management server node 410 can be configured to provide an execution environment configured to support the operation of the components illustrated in FIG. 3 and/or their analogs.

Illustrated in FIG. 3 is a lock-down service 300 including components adapted for operating in an execution environment 301. The execution environment 301, or an analog, can be provided by a node such as the management server node 410. The lock-down service 300 can include a data collection handler component 310 for receiving information from the plurality of nodes 420a-420e via a transport control channel 401, and a data store 320 for storing node information and other configuration information. The information received from the plurality of nodes 420a-420e may include, but is not limit to, system information and compliance logs for each node 420a-420e, such as CPU utilization, memory utilization, a system access log, a network access log, and the like.

With reference to FIG. 2, in block 202 a virtual topology comprising a secure computing zone in a cloud computing environment associated with an enterprise application of a private enterprise is determined. In an embodiment, the secure computing zone comprises a secure virtual vault. A system for protecting private enterprise computing resources in a cloud computing environment includes means for determining the virtual topology associated with the enterprise application. For example, FIG. 3 illustrates a virtual topology manager 342 in the lock-down service 300 configured to determine the virtual topology associated with the enterprise application of the private enterprise in the cloud computing environment, where the virtual topology comprises a secure computing zone, which in turn comprises a secure virtual vault.

In an embodiment, the virtual topology manager 342 can be adapted for operation in the execution environment 301 provided by a node device such as the management server node 410, where the virtual topology manager 342 can be included in a lock-down community manager 340 in the lock-down service 300. In an embodiment, the virtual topology manager 342 can be configured to receive virtual topology definitions for the secure computing zone from a security administrator 412 associated with the private enterprise 450. The security administrator 412 can provide the topology definitions to the management server node 410 via a private and/or public network 403, such as the Internet. The virtual topology manager 342 can, in an embodiment, receive the topology definitions via a user interface manager 330 in the lock-down service 300, or via any other suitable communication means.

The topology definitions can, in an embodiment, identify a secure computing zone 425 in the cloud computing environment 400, one or more secure virtual vaults 430a, 430b in the secure computing zone 425, a warehouse 440 in the computing zone 425, and/or one or more external sites 414 which may or may not be associated with the private enterprise 450, but is accessible by the secure computing zone 425.

According to an embodiment, the secure computing zone 425 is associated with an enterprise application of the private enterprise 450. For example, the enterprise application can be a web service application that provides web content of the private enterprise 450. In another example, the enterprise application can be a data mining tool that requires a large amount of computing resources for analysis on a burst need basis. In an embodiment, the virtual topology can include more than one secure computing zone associated with more than one enterprise application. In that case, the security administrator 412 can provide more than one topology definition for each of the more than one secure computing zones.

Referring again to FIG. 2, once the virtual topology associated with the enterprise application is determined in the cloud computing environment, a traffic control policy associated with the secure computing zone 425 is determined in block 204. In an embodiment, the traffic control policy comprises a plurality of security rules that define data traffic flow into, out of, and within the associated secure computing zone 425. A system for protecting private enterprise resources in a cloud computing environment includes means for determining the traffic control policy. For example, the virtual topology manager 342 in the lock-down community manager 340 can be configured to determine the traffic control policy associated with the secure computing zone 425.

According to an embodiment, the virtual topology manager 342 can be configured to receive traffic control policy definitions from the security administrator 412 associated with the private enterprise 450. The security administrator 412 can provide the traffic control policy definitions to the management server node 410 via the network 403. The virtual topology manager 342 can, in an embodiment, receive the traffic control policy definitions via the user interface manager 330 in the lock-down service 300, or via any other suitable communication means.

As noted above, the traffic control policy is associated with the secure computing zone 425 and comprises security rules that define data traffic flow into, out of and within the associated secure computing zone 425. For example, a first security rule can allow forward and backward data traffic flow between cloud computing nodes, e.g., 420a-420c, within a first secure virtual vault 430a. In FIG. 4, for example, solid line arrows between the cloud computing nodes 420a-420c indicate that Cloud Node 1 420a is allowed to send data to Cloud Node 2 420b and Cloud Node 3 420c, and that Cloud Node 2 420b and Cloud Node 3 420c are allowed to receive data from Cloud Node 1 420a. In addition, Cloud Node 2 420b is allowed to send data to Cloud Node 1 420a and Cloud Node 3 420c, and that Cloud Node 1 420a and Cloud Node 3 420c are allowed to receive data from Cloud Node 2 420b. Similarly, Cloud Node 3 420c is allowed to send data to Cloud Node 2 420b and Cloud Node 1 420a, and that Cloud Node 2 420b and Cloud Node 1 420a are allowed to receive data from Cloud Node 3 420c.

Alternatively or in addition, another security rule can prohibit data traffic flow between cloud computing nodes within a secure virtual vault. For example, a second security rule can block data traffic flow between cloud computing nodes 420d, 420e within a second secure virtual vault 430b. In FIG. 4, broken line arrows between the cloud computing nodes 420d, 420e indicate that Cloud Node 4 420d is not allowed to send data to Cloud Node 5 420e and vice versa, and that Cloud Node 5 420e is not allowed to receive data from Cloud Node 4 420d and vice versa. In this embodiment, the second secure virtual vault 430b can be referred to as a “silo” vault because the cloud computing nodes 420d, 420e in the vault 430b exist independently and are completely isolated from one another.

In an embodiment, the data traffic control policy associated with the secure computing zone 425 can include a security rule that allows the first secure virtual vault 430a to receive data from and to send reply data to a user/client device 402 via the network 403. In an embodiment, the security rule can identify a network port, e.g., Port 80, through which the data can be received from and through which the reply can be sent to the user/client device 402. Additionally, the data traffic control policy can include another security rule that, in an embodiment, does not allow the first virtual vault 430a to send forward data traffic to the user/client device 402. For example, such a security rule is commonly referred to as a type of “reverse firewall”.

In addition or alternatively, the data traffic control policy can include a security rule that allows the first secure virtual vault 430a to send data to, and to receive reply data from, the second secure virtual vault 430b. In an embodiment, the security rule can identify a network address associated with the second secure virtual vault 430b and/or a network port, e.g., Port 200, through which the data can be sent and through which the reply can be received. Additionally, the data traffic control policy can include another security rule that, in an embodiment, does not allow the first virtual vault 430a to receive forward data traffic from the second virtual vault 430b.

According to an embodiment, when data traffic is allowed between the first secure virtual vault 430a and the second secure virtual vault 430b, the respective security rules defining data traffic flow between the first 430a and second 430b virtual vaults can be interrelated, but different. For example, when a first security rule allows the first secure virtual vault 430a to send data to, and to receive reply data from, the second secure virtual vault 430b, a second interrelated security rule allows the second secure virtual vault 430b to receive data from, and to send reply data to, the first secure virtual vault 430a. Similarly, when another security rule does not allow the first virtual vault 430a to receive forward data traffic from the second virtual vault 430b, the interrelated security rule does not allow the second secure virtual vault 430b to send forward data to the first secure virtual vault 430a.

In another embodiment, the data traffic control policy associated with the secure computing zone 425 can include a security rule that allows the second secure virtual vault 430b to send data to, and to receive reply data from, an external site 414, e.g., a database service. In an embodiment, the security rule can identify a range of network addresses associated with the external site 414, a network port, e.g., Port 6000, and/or a network protocol, e.g. TCP, through which the data can be sent and through which the reply data can be received. Additionally, the data traffic control policy can include another security rule that, in an embodiment, does not allow the second secure virtual vault 430b to receive forward data traffic from the external site 414.

The security rules discussed above exemplify a standard two tiered web service enterprise application. For example, at a first tier, the first secure virtual vault 430a can represent a webpage service, and is allowed to receive inbound network traffic, e.g., a request for data, from a user/client device 402 over the network 403 via port 80. The first secure virtual vault 430a is allowed to send data, e.g., a query in the request, to the second secure virtual vault 430b at a second tier and the second secure virtual vault 430b is allowed to receive the data via port 200. The second secure virtual vault 430b can represent a database service that has access to an external database hosted by the external site 414. Accordingly, the second secure virtual vault 430b can send the query to the external site 414 and can receive a reply from the external site 414 via port 6000. The second secure virtual vault 430b (database service) can return the reply, which includes a query result, to the first secure virtual vault 430a via port 200. In turn, the first secure virtual vault 430a (webpage service) can return the query result corresponding to the data requested to the user/client device 402 over the network 403 via port 80.

According to the exemplary traffic control policy associated with the secure computing zone, the webpage service cannot initiate communications with the user/client device 402, and cannot receive unsolicited data from the database service. Moreover, in an embodiment, unless otherwise allowed, the webpage service cannot initiate communications with or receive unsolicited data from the external site 414. Similarly, the database service cannot initiate communication with the webpage service and cannot receive unsolicited data from the external site 414, and unless otherwise allowed, cannot initiate communication with or receive unsolicited data from the user/client device 402.

This example is but one way of illustrating how the traffic control policy for an enterprise application associated with a secure computing zone can be designed and determined to suit the needs of the private enterprise 450. Other policies and security rules can be implemented to support other enterprise applications, and to create single or multi-tiered data traffic control flows between non-cloud and cloud computing resources.

In an embodiment, the traffic control policy associated with the secure computing zone 425 includes a security rule that allows forward and backward data traffic from and to the management server node 410 via the control transport channel 401 communicatively connecting the management server node 410 to the secure computing zone 425, and in turn, to the secure virtual vault(s) 430a, 430b. This security rule can be inherently included or explicitly determined by the virtual topology manager 342.

Referring again to FIG. 2, once the virtual topology associated with the enterprise application of the private enterprise 450 is determined and the traffic control policy associated with the secure computing zone 425 is determined, a plurality of cloud computing nodes is selected, in block 206, and associated with the secure virtual vault 430a, in block 208. In an embodiment, any of the plurality of cloud computing nodes can be a physical computer device or a virtual computer provided by a physical computer device. A system for protecting private enterprise resources in a cloud computing environment includes means for selecting the cloud computing nodes and associating them with the secure virtual vault 430a in the secure computing zone 425. For example, a secure grid manager 344 in the lock-down service 300 can be configured to select the plurality of cloud computing nodes and to associate the selected nodes with the secure virtual vault 430a.

According to an embodiment, the secure grid manager 344 can be adapted for operation in the execution environment 301 provided by a node device such as the management server node 410, where the secure grid manager 344 can be included in a lock-down community manager 340 in the lock-down service 300. In an embodiment, the secure grid manager 344 can be configured to receive an indication selecting the plurality of cloud computing nodes from the security administrator 412 associated with the private enterprise 450. The security administrator 412 can provide the indication to the management server node 410 via the network 403. The secure grid manager 344 can, in an embodiment, receive the indication via the user interface manager 330 in the lock-down service 300, or via any other suitable communication means.

For example, in the public cloud environment 400, the cloud service provider can allocate one or more cloud computing nodes (not shown) into the warehouse 440 in the secure computing zone 425 associated with the enterprise application of the private enterprise 450 for the private enterprise's use. Through the user interface manager 330, the security administrator 412 can, in an embodiment, direct the secure grid manager 344 to select one or more cloud computing nodes in the warehouse 440 and to associate the selected nodes with the secure virtual vault 430a by assigning or moving them to the secure virtual vault 430a. For example, FIG. 4 illustrates that the secure grid manager 344 was directed to select Nodes 1-3 420a-420c from the warehouse 440 and to associate them with, i.e., move them into, the first secure virtual vault 430a. Similarly, when the secure computing zone 425 includes, in an embodiment, more than one secure virtual vault, e.g., 430b, a second plurality of cloud computing nodes can be selected and associated with a second secure virtual vault 430b.

Referring again to FIG. 2, once the plurality of nodes is selected and associated with the secure virtual vault, the traffic control policy associated with the secure computing zone is automatically implemented in each of the plurality of cloud computing nodes associated with the secure virtual vault in block 210. According to an embodiment, each cloud computing node is configured to enforce the plurality of security rules at an operating system level of the cloud computing node. A system for protecting private enterprise resources in a cloud computing environment includes means for implementing the traffic control policy in each of the plurality of cloud computing nodes. For example, the secure grid manager 344 can be configured to automatically implement the traffic control policy associated with the secure computing zone in each of the plurality of cloud computing nodes associated with the secure virtual vault.

According to an embodiment, the secure grid manager 344 can receive the traffic control policy associated with the secure computing zone 425 from the virtual topology manager 342, and can identify at least one security rule in the traffic control policy defining data traffic flow into, out of, and/or within the secure virtual vault, e.g., 430a. Based on the identified security rule(s), the secure grid manager 344 can be configured to generate an approved resource list associated with the secure virtual vault 430a that identifies all resources with which the plurality of cloud computing nodes 420a-420c is allowed to communicate. As used in this description, a resource can include cloud computing nodes, applications in a cloud computing node, external sites, and other network accessible physical or virtual nodes. Accordingly, a resource can be identified by a network address, e.g., IP address, a range of network addresses, and/or a network port.

For example, in an embodiment where the traffic control policy includes a security rule that allows data traffic flow between each of the plurality of cloud computing nodes 420a-420c associated with the secure virtual vault 430a, the secure grid manager 344 can automatically generate an approved resource list that identifies each of the plurality of cloud computing nodes 420a-420c. In an embodiment, the approved resource list is associated with the secure virtual vault 430a, and can identify each of the plurality of computing nodes 420a-420c by a network port and/or a network address, as well as a network protocol.

Alternatively or in addition, when the traffic control policy includes a security rule that allows data traffic flow between the first secure virtual vault 430a and a second secure virtual vault, e.g., 430b, the approved resource list associated with the first secure virtual vault 430a can identify each of the plurality of cloud computing nodes 420d, 420e associated with the second secure virtual vault 430b. Similarly, the approved resource list associated with the second secure virtual vault 430b can identify each of the plurality of cloud computing nodes 420a-420c associated with the first secure virtual vault 430a. In addition, the approved resource lists associated with the first 430a and second 430b secure virtual vaults can, in an embodiment, indicate whether forward and/or backward traffic flow is allowed for each of the identified cloud computing nodes 420a-420e based on the traffic control policy associated with the secure computing zone 425.

In an embodiment, the approved resource list associated with the secure virtual vault 430a can be a practical application of the traffic control policy. Accordingly, as circumstances change, e.g., due to workload or node failures, the approved resource list can be updated easily and automatically to reflect the change without affecting the traffic control policy.

According to an embodiment, the secure grid manager 344 can be configured to provide the approved resource list to each of the plurality of cloud computing nodes associated with the secure virtual vault 430a. For example, the secure grid manager 344 can invoke a command handler 306 in the lock-down service 300. The command handler 306 can be configured to generate a message formatted according to a variety of schemas that identifies the secure virtual vault 430a and/or each of the plurality of cloud computing nodes, e.g., Nodes 1-3 420a-420c, associated with the secure virtual vault 430a. In addition, the message can include, in an embodiment, the approved resource list associated with the secure virtual vault 430a and an indication to upload the approved resource list to the operating system level of a receiving cloud computing node, e.g., Nodes 1-3 420a-420c. According to an embodiment, the message can also include an indication to store the approved resource list in an IP table provided by the operating system of each cloud computing node 420a-420c.

In an embodiment where the secure computing zone 425 includes more than one secure virtual vault, e.g., first 430a and second 430b secure virtual vaults, the secure grid manager 344 can be configured to automatically implement the traffic control policy in each of the cloud computing nodes associated with the first 430a and second 430b secure virtual vaults by generating a first approved resource list associated with the first secure virtual vault 430a and generating a second approved resource list associated with the second secure virtual vault 430b. For example, in an embodiment, the first approved resource list can be generated based on at least one security rule defining data traffic flow into, out of, and within the first secure virtual vault 430a and the second approved resource list can be generated based on a security rule(s) defining data traffic flow into, out of, and within the second secure virtual vault 430b. Once the first and second approved resource lists are generated, they can be provided to each of the cloud computer nodes 420a-420f associated with the first 430a and second 430b secure virtual vaults, respectively.

For example, in an embodiment, the secure grid manager 344 can invoke the command handler 306 to generate first and second messages corresponding to the first 430a and second 430b secure virtual vaults respectively. The first message, for example, can identify the first secure virtual vault 430a and/or each of the plurality of cloud computing nodes, e.g., Nodes 1-3 420a-420c, associated with the first secure virtual vault 430a, and can include the approved resource list associated with the first secure virtual vault 430a. Similarly, the second message can identify the second secure virtual vault 430b and/or each of the plurality of cloud computing nodes, e.g., Nodes 4-5 420d, 420e, associated with the second secure virtual vault 430b, and can include the approved resource list associated with the second secure virtual vault 430b.

Once the message, e.g., the first message and/or the second message, is generated, the message handler 308 can be configured to send the message, e.g., the first message, to each of the plurality of cloud computing nodes 420a-420c based on the information identifying the secure virtual vault 430a and/or each of the plurality of cloud computing nodes 420a-420c. For example, the message handler component 308, in an embodiment, can be configured to send the message to each cloud computing node 420a-420c associated with the secure virtual vault 430a via the control transport channel 401 according to a suitable communication protocol, of which a large number exist or can be defined.

In an embodiment, the message(s) can be provided to a protocol layer 303, which can be configured to package the message for sending. Such packaging can include reformatting the message, breaking the message into packets, including at least a portion of the message along with at least a portion of another message to be transmitted together, and/or adding additional information such as a header or trailer as specified by the protocol used. In this manner, the traffic control policy is implemented in each of the plurality of cloud computing nodes 420a-420c associated with the secure virtual vault 430a.

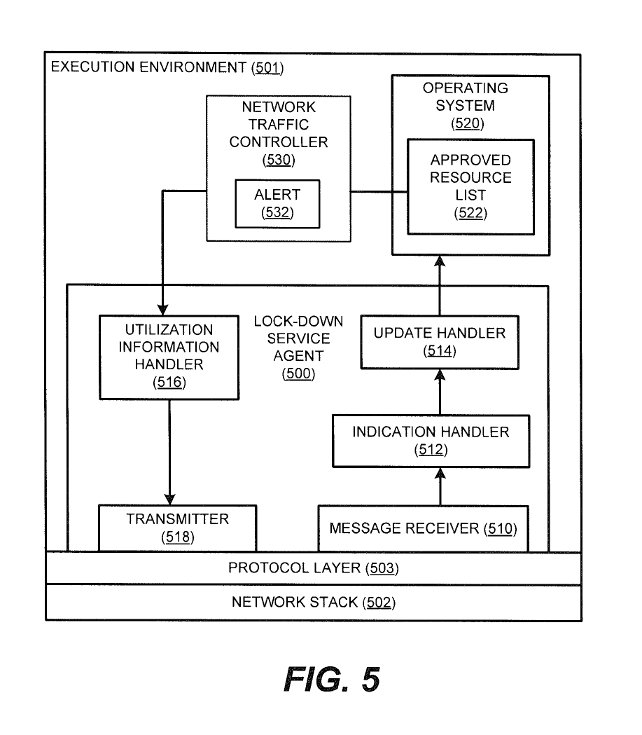

FIG. 5 is a block diagram illustrating an exemplary execution environment provided by a cloud computing node, e.g., Node 1 420a, according to an embodiment. The exemplary execution environment 501 can host a lock-down service agent 500, and an operating system 520, which maintains an approved resource list 522 associated with the secure virtual vault, e.g., 430a, with which the cloud computing node 420a is associated.

According to an embodiment, an indication handler 512 in the lock-down service agent 500 can be configured to receive the indication to upload and/or to store the approved resource list 522 in the message sent from the management server node 410 over the control transport channel 401. According to an embodiment, the message can be transmitted over the channel 401 and received by a network stack 502 in the execution environment 501. The network stack 502 can be configured to provide the message to a communication protocol layer 503, which in turn can pass the message to the indication handler 512 via a message receiver 510 in the lock-down service agent 500.

In an embodiment, when the indication handler 512 receives the message, the indication handler component 512 can be configured to determine that the message includes an indication to upload and/or to store the approved resource list 522, and can invoke an update handler 514 to process the upload and/or store indication. In an embodiment, the update handler 512 can be configured to upload and store the approved resource list 522 into the operating system 520 of the cloud computing node 420a. In addition, the update handler 514 can be configured to update the approved resource list 522 by adding or removing a resource to and from the approved resource list 522, for example, when a cloud computing node is added or removed from the secure virtual vault 430a. As noted above, such changes can be implemented without affecting the traffic control policy associated with the secure computing zone 425. Additionally, the update handler 514 can be configured to replace a first list with a second list when, for example, resources in the secure virtual vault 430a are being replaced with resources in another secure virtual vault, e.g., 430b.

According to an exemplary embodiment, the execution environment 501 includes a network traffic controller 530, which is configured to monitor all network communications involving the cloud computing node 420a. In an embodiment, the network traffic controller 530 monitors any data traffic entering the cloud node 420a and any data traffic exiting the cloud node 420a to detect abnormal and/or prohibited communications. When data traffic is received or sent by the cloud node 420a, the network traffic controller 530 can be configured to determine whether the data traffic is allowed based on the approved resource list 522.

For example, the network traffic controller 530 can determine that data traffic attempting to enter or exit the cloud node 420a via a network port is not allowed when the network port is not identified on the approved resource list 522. Additionally, the network traffic controller 530 can be configured to monitor the volume and/or pattern of network traffic to determine whether the data traffic is part of a malicious attack. For example, known malicious programs can cause a computing node to send continuous and numerous messages to another computing node, which when multiplied many times over can flood the network and potentially cause the receiving computing node to fail. The network traffic controller 530 can be configured to detect when the network traffic volume is abnormally high.

When the network traffic controller 530 detects an abnormal condition and/or a prohibited communication attempt, e.g., it determines that data traffic entering into or exiting from the cloud node 420a is not allowed or is allowed but is abnormally high, the network traffic controller 530 can be configured, in an embodiment, to identify an abnormal traffic condition and/or an attempt by the cloud node 420a to violate a security rule of the traffic control policy, and to determine that the cloud node 420a is a corrupted node. In such an event, the network traffic controller 530 can generate an alert 532 identifying the corrupted node 420a and the abnormal traffic condition and/or the attempt by the corrupted cloud node 420a to violate the security rule. In an embodiment, the network traffic controller 530 can invoke a utilization information handler 516 in the lock-down service agent 500 to send the alert 532 to the management server node 410 via the control transport channel 401.

According to an embodiment, the alert 532 relating to the corrupted cloud computing node 420a can be received by the secure grid manager 344 via the network stack 302 in the execution environment 301. The network stack 302 can be configured to provide the alert 532 to the communication protocol layer 303, which in turn can pass the information to the data collection handler component 310. In one embodiment, the data collection handler component 310 can route the alert 532 to the secure grid manager 344, which can be configured to present the alert 532 to the security administrator 412, who can then take responsive action.

For example, according to an exemplary embodiment, when such an alert 532 is received, the secure grid manager 344 can be configured to invoke the command handler 306 to generate a warning message identifying the corrupted cloud computing node 420a. The warning message, in an embodiment, can then be provided to the security administrator 412 associated with the private enterprise 450 over the network 403.

Alternatively or in addition, when such an alert 532 is received, the secure grid manager 344 can be configured to automatically isolate the corrupted cloud computing node 420a from the other cloud computing nodes associated with the same secure virtual vault 430a and/or associated with a different secure virtual vault 430b when data traffic between the secure virtual vaults 430a, 430b is allowed. For example, in an embodiment, the secure grid manager 344 can be configured to update automatically the approved resource list 522 associated with the secure virtual vault 430a with which the corrupted cloud computing node 420a is associated, as well as the approved resource list 522 associated with another secure virtual vault 430b when data traffic between vaults 430a, 430b is allowed. In an embodiment, the update to the approved list(s) 522 can operate to block any data traffic from or to the corrupted computing node 420a thereby isolating the node 420a until further investigations can be performed. Once the approved resource list(s) is (are) updated, the secure grid manager 344 can invoke the command handler 306 to generate a message(s) including, in an embodiment, the updated approved resource list and an indication to replace the existing approved resource list with the updated approved resource list.

In another embodiment, when the alert 532 is received, the secure grid manager 344 can identify the corrupted cloud computing node 420a and invoke the command handler 306 to generate a message that includes an indication to remove the corrupted cloud computing node 420a from the approved resource list 522. The message can also identify one or more secure virtual vaults and/or a plurality of cloud computing nodes 420a-420e affected by the removal of the corrupted cloud computing node 420a.

For example, in an embodiment where the secure computing zone 425 includes more than one secure virtual vault, e.g., first 430a and second 430b secure virtual vaults, and the traffic control policy allows data traffic between the first 430a and second 430b secure virtual vaults, the secure grid manager 344 can update the approved resource lists associated with each secure virtual vault to block any data traffic from and to the corrupted cloud computing node 420a. The command handler 306 can be invoked to generate first and second messages corresponding to the first 430a and second 430b secure virtual vaults respectively. The first message, for example, can include the updated approved resource list associated with the first secure virtual vault 430a. Similarly, the second message can include the updated approved resource list associated with the second secure virtual vault 430b. Alternatively, the command handler 306 can generate a message including an indication to remove the corrupted node 420a from the associated approved resource list corresponding to both secure virtual vaults. Accordingly, security rules can be modified and implemented easily and dynamically to protect uncorrupted resources in the secure computing zone 425.

Once the message(s) is generated, the message handler 308 can be configured to send the message to each of the plurality of cloud computing nodes 420a-420c associated with the secure virtual vault 430a, thereby providing the updated approved resource list to the cloud computing nodes 420a-420c associated with the secure virtual vault 430a. For example, the message handler component 308, in an embodiment, can be configured to send the message to each cloud computing node 420a-420c associated with the secure virtual vault 430a via the control transport channel 401 according to a suitable communication protocol, of which a large number exist or can be defined. When the approved resource list 522 is updated by the cloud computing nodes 420a-420c, the corrupted cloud computing node 420a can be effectively isolated from the other nodes 420b, 420c associated with the secure virtual vault 430a.

According to another embodiment, a cloud computing node can easily be added to or removed from a secure virtual vault in a similar manner. For example, in an embodiment, the secure grid manager 344 can receive an indication to add or remove a target cloud computing node (not shown) to or from a secure virtual vault, e.g., 430b. Such an indication can be received, for example, from the security administrator 412 when activity or workload levels relating to the secure virtual vault 430b increase or decrease and the private enterprise 450 wishes to reallocate its resources in the cloud environment 400.

When such an indication is received, the secure grid manager 344 can update automatically the approved resource list associated with the secure virtual vault 430b based on the indication to add or remove the target cloud computing node, and the updated approved resource list can be provided to each of the plurality of cloud computing nodes 420d, 420e associated with the secure virtual vault 430b. For example, as described above, the command handler 306 can be invoked to generate a message including, in an embodiment, the updated approved resource list and a command to replace the existing approved resource list with the updated approved resource list, and the message handler 306 can transmit the message to each of the plurality of cloud computing nodes 420d, 420e.

According to another embodiment, the lock-down service 300 in the management server node 410 can be configured to detect an interruption in the control transport channel 401 communicatively connecting the management server node 410 to the secure computing zone 425, the secure virtual vaults 430a, 430b, and/or the cloud computing nodes 420a-420e. For example, the lock-down service 300 can be configured to send periodic status requests over the channel 401 to the cloud computing nodes 420a-420e, and when no replies are received can determine that the channel 401 is interrupted. When such an event is detected, the lock-down service 300 can be configured to reestablish the control transport channel 401 and to check a status of each of the plurality of cloud computing nodes 420a-420e.

According to embodiments described herein, the lock-down service 300 in the management server node 410 allows a private enterprise 450 to define a virtual topology that includes a secure computing zone 425 associated with an enterprise application of the private enterprise 450. The secure computing zone 425 can have at least one secure virtual vault 430a, 430b, a warehouse 440, external sites 414, and other network accessible resources. Moreover, the enterprise 450 can be allowed to define a traffic control policy that dictates how data traffic flows into, out of, and within a secure computing zone 425. Once the traffic control policy is defined for the secure computing zone 425, cloud computing nodes 420a-420e can be selected and associated with each secure virtual vault 430a, 430b.

According to an embodiment, the traffic control policy can be implemented automatically in each cloud computing node 420a-420e, which is configured to enforce the policy at the operating system level of the cloud computing node 420a. As described above, the lock-down service 300 can be configured to transform the traffic control policy into a list of resources that embodies the security rules and that can be enforced at the operating system level of the cloud computing node.

The approved resource list described above is an example of what is referred to as a “white” list, which identifies resources with which the cloud computing node can communicate. Those skilled in security management, however, will appreciate that the list of resources can also be what is referred to as a “black” list, which explicitly identifies resources with which the cloud computing node cannot communicate. In either case, the approved resources are identifiable. For instance, in the “white” list, the approved resources are explicitly identified, while in the “black” list, the approved resources are implicitly identified. Accordingly, the approved resource list described herein can be a white list, a black list or any combination thereof, and should not be limited to being a white list only.

In an embodiment, the lock-down service 300 in the management server node 410 can allow the private enterprise 450 to define more than one virtual topology where each topology can be associated with a different enterprise application. For example, the private enterprise 450 may wish to utilize the cloud 400 to host its web service and its customer relationship management (CRM) system. In this case, a first virtual topology associated with the web service can be determined and a second virtual topology associated with the CRM system can be determined.

In an embodiment, the enterprise 450 can easily fortify the security of its cloud computing environment 400 and protect its resources without changing or modifying the underlying and existing hardware or virtual machine hypervisors. In a public cloud computing environment 400, while the existing underlying hardware infrastructure is typically well protected by the cloud service provider, the enterprise 450 can further control and protect its specific rental resources and applications without depending on or modifying the existing underlying hardware or virtual machine hypervisors.

Because the approach described does not require manual reconfiguration of network topology via network node devices, e.g., switches and routers, at a physical network level, virtual and/or physical resources in the cloud computing environment 400 can be logically segregated into secure virtual vaults 430a, 430b where data traffic into, out of and within a vault 430a can be controlled, and data traffic between vaults 430a, 430b can be effectively controlled or blocked. When the secure computing zone 425 associated with the enterprise application includes thousands of cloud computing nodes, the traffic flow into, out of, within and between the secure virtual vaults 430a, 430b can be configured and reconfigured dynamically and easily by automatically updating the approved resource lists maintained by the operating systems of the cloud computing nodes.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for protecting private enterprise computing resources in a cloud computing environment, the method comprising:
determining by a server a virtual topology comprising a secure computing zone associated with an enterprise application of a private enterprise in a cloud computing environment, the secure computing zone comprising a secure virtual vault;
determining by the server a traffic control policy associated with the secure computing zone, wherein the traffic control policy comprises a plurality of security rules that define data traffic flow into, out of, and within the associated secure computing zone;
selecting by the server a plurality of cloud computing nodes, wherein any of the plurality of cloud computing nodes is one of a virtual computer and a physical computer device;
associating by the server the plurality of cloud computing nodes with the secure virtual vault; and
implementing automatically by the server the traffic control policy associated with the secure computing zone in each of the plurality of cloud computing nodes associated with the secure virtual vault, wherein each cloud computing node is configured to enforce the plurality of security rules at an operating system level of the cloud computing node.

2. The method of claim 1 wherein the cloud computing environment is a public cloud environment provided by an independent service provider, and wherein the independent service provider provides at least one of physical and virtual cloud resources to the private enterprise for a fee.

3. The method of claim 2 wherein the server is a cloud resource in the public cloud environment provided by the independent service provider.

4. The method of claim 1 wherein the server is in a demilitarized zone (DMZ) associated with a secure enterprise network of the private enterprise.

5. The method of claim 1 wherein determining the virtual topology and determining the traffic control policy comprises receiving virtual topology definitions and traffic control policy definitions from a security administrator associated with the private enterprise over at least one of a private and a public network.

6. The method of claim 1 wherein the secure computing zone includes a first secure virtual vault and a second secure virtual vault and wherein the method further includes:
selecting and associating by the server a first plurality of cloud computing nodes with the first secure virtual vault;
selecting and associating by the server a second plurality of cloud computing nodes with the second secure virtual vault; and
implementing by the server the traffic control policy associated with the secure computing zone in each of the first plurality of cloud computing nodes associated with the first secure virtual vault and in each of the plurality of second cloud computing nodes associated with the second secure virtual vault, wherein the traffic control policy comprises a plurality of security rules that define data traffic flow into and out of the secure computing zone, and data traffic flow within and between the first and second secure virtual vaults.

7. The method of claim 6 wherein at least a portion of the plurality of security rules are interrelated when data traffic between the first secure virtual vault and the second secure virtual vault is permitted.

8. The method of claim 1 wherein the virtual topology includes an external site, and wherein the traffic control policy includes a security rule that controls data traffic flow between the secure virtual vault and the external site.

9. The method of claim 1 wherein implementing the traffic control policy in each of the plurality of cloud nodes comprises:
identifying by the server at least one security rule in the traffic control policy defining at least one of data traffic flow into, out of, and within the secure virtual vault;
generating by the server an approved resource list associated with the secure virtual vault based on the at least one identified security rule, the approved resource list identifying all resources with which the plurality of cloud computing nodes is allowed to communicate; and
providing the approved resource list associated with the secure virtual vault to each of the plurality of cloud computing nodes associated with the secure virtual vault, wherein the approved resource list is maintained at the operating system level of each of the plurality of cloud computing nodes.

10. The method of claim 9 wherein the approved resource list includes at least one of a network port, a network address, and a network protocol associated with each identified resource, and wherein the approved resource list is stored in an IP table provided by the operating system of the cloud computing node.

11. The method of claim 9 further comprising:
receiving by the server an indication to add or remove a target cloud computing node to or from the secure virtual vault;
based on the indication to add or remove the target cloud computing node, updating automatically the approved resource list associated with the secure virtual vault; and
providing the updated approved resource list to each of the plurality of cloud computing nodes associated with the secure virtual vault, wherein each cloud computing node is configured to replace the approved resource list with the updated approved resource list.

12. The method of claim 1 further comprising:
receiving by the server an alert relating to a corrupted cloud computing node, wherein the corrupted cloud computing node is one of the plurality of computing nodes associated with the secure virtual vault, the alert identifying at least one of an abnormal traffic condition and an attempt by the corrupted cloud computing node to violate a security rule of the plurality of security rules;
generating, automatically by the server, a warning message identifying the corrupted cloud computing node; and
providing, by the server, the warning message to a security administrator associated with the private enterprise over at least one of a private and a public network.

13. The method of claim 9 further comprising:
receiving, by the server, an alert relating to a corrupted cloud computing node, wherein the corrupted cloud computing node is one of the plurality of computing nodes associated with the secure virtual vault, the alert identifying at least one of an abnormal traffic condition and an attempt by the corrupted cloud computing node to violate a security rule of the plurality of security rules;
updating, automatically by the server, the approved resource list associated with the secure virtual vault to block any data traffic from and to the corrupted cloud computing node; and
providing the updated approved resource list to each of the plurality of cloud computing nodes associated with the secure virtual vault, thereby isolating the corrupted cloud computing node from the plurality of cloud computing nodes associated with the secure virtual vault.

14. The method of claim 1 wherein a security rule included in the traffic control policy allows forward and backward data traffic from and to the server via a control transport channel communicatively connecting the server to at least one of the secure computing zone, the secure virtual vault, and the plurality of cloud computing nodes.

15. The method of claim 14 further comprising:
detecting by the server an interruption in the control transport channel;
reestablishing the control transport channel; and
checking automatically a status of each of the plurality of cloud computing nodes.

16. A method for protecting private enterprise computing resources in a cloud computing environment, the method comprising:
determining by a server a virtual topology comprising a secure computing zone associated with an enterprise application of a private enterprise in a cloud environment, the secure computing zone comprising a first secure virtual vault and a second secure virtual vault;
determining by the server a traffic control policy associated with the secure computing zone, wherein the traffic control policy comprises a plurality of security rules that define data traffic flow into and out of the secure computing zone, and, data traffic flow within and between the first and second secure virtual vaults;
selecting by the server a first plurality of cloud computing nodes and associating the first plurality of cloud computing nodes with the first secure virtual vault;
selecting by the server a second plurality of cloud computing nodes and associating the second plurality of cloud computing nodes with the second secure virtual vault;
implementing automatically by the server the traffic control policy associated with the secure computing zone in each of the first plurality of cloud computing nodes associated with the first secure virtual vault; and in each of the second plurality of cloud computing nodes associated with the second secure virtual vault, wherein each of the first and second pluralities of cloud computing nodes is configured to enforce the plurality of security rules at an operating system level of the cloud computing node.

17. The method of claim 16 wherein implementing the traffic control policy in each of the first and second plurality of cloud nodes comprises:
identifying by the server at least one first security rule in the traffic control policy defining at least one of data traffic flow into, out of, and within the first secure virtual vault;
generating by the server a first approved resource list associated with the first secure virtual vault based on the at least one identified first security rule, the first approved resource list identifying all resources with which the first plurality of cloud computing nodes is allowed to communicate;
identifying by the server at least one second security rule in the traffic control policy defining at least one of data traffic flow into, out of, and within the second secure virtual vault;
generating by the server a second approved resource list associated with the second secure virtual vault based on the at least one identified second security rule, the second approved resource list identifying all resources with which the second plurality of cloud computing nodes is allowed to communicate;
providing the first approved resource list associated with the first secure virtual vault to each of the first plurality of cloud computing nodes associated with the first secure virtual vault, wherein the first approved resource list is maintained at the operating system level of each of the first plurality of cloud computing nodes; and
providing the second approved resource list associated with the second secure virtual vault to each of the second plurality of cloud computing nodes associated with the second secure virtual vault, wherein the second approved resource list is maintained at the operating system level of each of the second plurality of cloud computing nodes.

18. The method of claim 17 wherein at least one security rule allows data traffic flow between the first and second secure vaults, the method further comprising:
receiving by the server an indication to add or remove a target cloud computing node to or from the first secure virtual vault;
based on the indication to add or remove the target cloud computing node, updating automatically the first approved resource list associated with the first secure virtual vault and the second approved resource list associated with the second secure virtual vault;
providing the updated first approved resource list to each of the plurality of cloud computing nodes associated with the first secure virtual vault; and
providing the updated second approved resource list to each of the plurality of cloud computing nodes associated with the second secure virtual vault, wherein each cloud computing node is configured to replace the approved resource list with the updated approved resource list.

19. A machine-readable medium carrying one or more sequences of instructions for protecting private enterprise computing resources in a cloud computing environment, which instructions, when executed by one or more processors, cause the one or more processors to carry out the steps of:
determining by a server a virtual topology comprising a secure computing zone associated with an enterprise application of a private enterprise in a cloud computing environment, the secure computing zone comprising a secure virtual vault;
determining by the server a traffic control policy associated with the secure computing zone, wherein the traffic control policy comprises a plurality of security rules that define data traffic flow into, out of, and within the associated secure computing zone;
selecting by the server a plurality of cloud computing nodes, wherein any of the plurality of cloud computing nodes is one of a virtual computer and a physical computer device;
associating automatically by the server the plurality of cloud computing nodes with the secure virtual vault; and
implementing automatically by the server the traffic control policy associated with the secure computing zone in each of the plurality of cloud computing nodes associated with the secure virtual vault, wherein each cloud computing node is configured to enforce the plurality of security rules at an operating system level of the cloud computing node.

20. A system for protecting private enterprise computing resources in a cloud computing environment, the apparatus comprising:
a processor; and
one or more stored sequences of instructions which, when executed by the processor, cause the processor to carry out the steps of:
determining by a server a virtual topology comprising a secure computing zone associated with an enterprise application of a private enterprise in a cloud computing environment, the secure computing zone comprising a secure virtual vault;
determining by the server a traffic control policy associated with the secure computing zone, wherein the traffic control policy comprises a plurality of security rules that define data traffic flow into, out of, and within the associated secure computing zone;
selecting by the server a plurality of cloud computing nodes, wherein any of the plurality of cloud computing nodes is one of a virtual computer and a physical computer device;
associating automatically by the server the plurality of cloud computing nodes with the secure virtual vault; and
implementing automatically by the server the traffic control policy associated with the secure computing zone in each of the plurality of cloud computing nodes associated with the secure virtual vault, wherein each cloud computing node is configured to enforce the plurality of security rules at an operating system level of the cloud computing node.
